(19) United States
(12) Patent Application Publication
(10) Pub. No.: US 2010/0030626 A1
(43) Pub. Date: Feb. 4, 2010

(54) DISTRIBUTED SOFTWARE FAULT IDENTIFICATION AND REPAIR

(76) Inventors: John M. Hughes, Hebron, CT (US); Anthony Jefts, Warwick, RI (US); David Messinger, West Hartford, CT (US)

Correspondence Address: Goodwin Procter LLP, Patent Administrator, 53 State Street, Boston, MA, 02109-2881, US

(21) Appl. No.: 12/437,997

(22) Filed: May 8, 2009

Related U.S. Application Data
(60) Provisional application No. 61/051,676, filed on May 8, 2008.

(51) Int. Cl. G06Q 10/00; G06F 9/44; G06Q 20/00; G06Q 50/00

(52) U.S. Cl. 705/11; 717/103; 705/14.11

(57) ABSTRACT

This invention relates to methods and a system for supporting software. In one embodiment, a method for providing an updated version of a software program includes conducting a first competition for identifying faults in a software program and conducting a second competition for fixing the identified faults.

### RELATED APPLICATIONS

This application claims the benefit of and priority to U.S. Provisional Patent Application Ser. No. 61/051,676 filed on May 8, 2008, entitled DISTRIBUTED SOFTWARE FAULT IDENTIFICATION AND REPAIR by Hughes et al., attorney docket number TOP-022PR.

### TECHNICAL FIELD

This invention relates to computer-based methods and systems for developing and distributing software and, more particularly, to methods and systems for facilitating the distributed development of software.

### BACKGROUND INFORMATION

In the United States and elsewhere, computers have become part of people's everyday lives, both in the workplace and in personal endeavors. This is because a general-purpose computer can be programmed to run a variety of software programs each providing different processing and networking functions. Computer programmers develop computer code, and in many cases are also responsible for testing and assuring quality prior to release, and supporting computer code once it is released into a production and/or commercial environment. Some companies hire large numbers of computer programmers and support technicians to develop and support released code on the company's behalf.

One approach is to hire large numbers of programmers and develop and support software “in house.” While this affords significant control over the programming staff, finding, hiring, and maintaining such a staff can be cost prohibitive. Furthermore, as individual programmers leave the company, much of the technical and industrial knowledge is also lost. Alternatively, many companies “outsource” their software programming and support activities through consulting firms, third parties, or contract employees. This approach relieves the company of the burdens of managing individual employees, however the quality and consistency of the work may be suspect, and the challenges of integrating work from numerous outside vendors can be significant without appropriate processes in place.

### SUMMARY OF THE INVENTION

Organizations that develop and deploy software need to provide high-quality testing, quality assurance, and support for production software while being assured that any changes to the code are implemented using appropriate quality measures. Techniques that have been suggested to improve software development and simplify ongoing support are code re-use and component-based design. But even if organizations adopt such techniques, they still need to provide timely and quality testing, quality assurance, and support to users of the software in an affordable manner.

In general, the invention relates to providing infrastructure, process controls, and manpower to perform quality assurance testing and fixes of issues identified during such testing prior to release of such software as well as support of previously-released software using a repeatable, structured model in order to transform software quality assurance and support from an ad-hoc, low-value-add exercise into a streamlined, predictable manufacturing operation. Generally speaking, this goal can be achieved using a competition model whereby a number of distributed, unrelated, and motivated developers each submit fault identification information and/or fault repairs (e.g., code) to fix malfunctioning software programs, from which the eventual new, functional software program may be selected.

This approach can be applied in a variety of scenarios, even in cases where third-parties or other software development firms developed the software, but a company wishes to obtain support for the program elsewhere. For example, a consulting firm or an offshore programming shop may have been engaged to develop the software. In another example, the software may have been developed in-house, but the company wants to assist its development staff with the task of providing quality assurance and/or ongoing support for the program. In some cases, a multi-step software development manufacturing process, such as those described in currently pending, commonly assigned U.S. patent application Ser. No. 10/408,402 entitled “Method and System for Software Development” and U.S. patent application Ser. No. 11/035,783 entitled “Systems and Methods for Software Development” may be used to develop the software or a change in environment or other software. Even using such methods, however, the possibility exists that a programming error will cause the developed program to fail under one or more conditions.

In one aspect, an indication of a fault (used here to refer to an error, malfunction, bug and the like, as well as behavior that operates according to the specification or documentation but is not appropriate, acceptable or optimal for actual end-user activity) in a software program is received, and a description of the faulty behavior, and the faulty program (or directions for obtaining a copy of the faulty program) is communicated to a distributed community of programmers. In response, a fix to the software program may be received from each of a subset of the programmers. This may be in the form of the modified program, a set of changes to the modified program, a reference to the changes to the modified program, and so forth. One of the received modified versions is determined to be the preferred updated software program.

Various embodiments can include one or more of the following features. The faulty software program can originate from a production environment into which the program was previously deployed. The software program can be the result of one or more coding competitions such as an on-line contest, where, for example, the programmers' skill ratings can be derived from their performances in the coding competition. As further examples, the software program can be a software component, a software application, a combination of components, or a software module. In some cases, one or more test cases failure cases are received that cause the faulty software program to fail.

A copy of the faulty software program and/or a description of the fault can be received prior to, along with, or after receiving the indication of a fault in the software program, and the faulty program may be analyzed to determine the cause of the fault. In some embodiments, the description of the fault is distributed with the faulty program. A severity level can accompany the indication of fault and/or the distribution of the faulty program. In some cases a software specification and/or design document that was used to develop the faulty software program is also distributed. In some cases, one or more test cases are provided that the software program passes.

The distributed community of programmers can include (or in some cases be limited to) programmers who previously participated in an online programming competition, and in some embodiments those programmers who have achieved a rating above a predetermined minimum rating. The distributed community of programmers can include a programmer who previously designed and/or developed the faulty software program. A time limit may be imposed on the submission of updated versions of the software program. The determination of which submitted updated software program is identified as the preferred updated software program may be based on the extent to which the submitted programs address the indicated fault and/or the order in which the submissions were received. A list of parties using the faulty software program may be compiled, and in addition the preferred updated software program may be distributed to one or more of the identified parties.

The method can further include rewarding the programmer that found the fault and/or submitted the preferred updated software program with, for example, monetary rewards, prizes, and/or increased ratings. Submissions of updated versions of the faulty software program may be rejected after some predefined period of time, upon receiving a pre-defined number of submissions, or upon selecting a preferred updated software program.

In general, another aspect of the invention relates to systems for implementing the methods just described. For example, a system for providing updated versions of software programs includes a communications module for receiving an indication of a fault in a software program, distributing the faulty software program to a distributed community of programmers, and in response to the distribution, receiving from each of a subset of the programmers an updated version of the faulty software program and one or more test cases for testing the received program. The system also includes a component storage module for storing previously distributed versions of the faulty software program and a testing module for determining a preferred updated version of the faulty software program, using, for example, test cases submitted with the updated versions of the software program.

In one embodiment of this aspect of the invention, the system further includes a rating engine for rating the skills of the members of the distributed community of programmers in response to the received updated versions of the faulty software program. The system can, in some embodiments, further include a reviewing module to allow members of the distributed community to review updated versions of the faulty software program submitted by other members of the community. A repository may be used to store the received updated versions, and in some cases a version control module may be included to maintain multiple versions of the software program, one of which may be the preferred version of the updated software program.

In some embodiments, the distributed community of developers also may be used to test software and identify faults. For example, the distributed community of developers may be provided with the software application, and be asked to try the operation of the software application program to see whether its features meet specifications and/or user expectations. The first developer(s) who submit verifiable faults may receive a reward. For example, a “bounty” may be put out for faults, and members of the community may receive the bounty if they identify faults. In some cases, they may receive a different bounty depending on whether they are the first to find the fault, or depending on the type of fault identified. In some embodiments, in which a software application is being tested, user interface faults are worth a certain number of points, and back-end operation faults are worth a different number of points. A developer's points are totaled at the end of a time period, and a prize pool apportioned based on the points. In another embodiment, a developer's points are totaled, and the points are included in a grand prize pool. Cash prizes may be awarded instead or in addition.

In some embodiments, points are awarded for each fault accepted, and a prize awarded to the developer(s) with the most points. Lesser prizes also may be paid based on points. In one embodiment, a prize (e.g., $2, $4, $10, etc.) may be awarded for each fault identification description that is accepted, and a larger prize awarded to the developer(s) who submit the greatest number of fault identifications. Acceptance of the faults may be determined by one or more designated individuals, including but not limited to an administrator, customer, developer appointed as a reviewer, and so on.

In some embodiments, the distributed community of developers may be used both to find faults and to fix them. A software program first may be opened up to fault identification. The faults may be identified by administrators and/or by the number of times that the fault is reported by different developers. Prizes (e.g., points, money, etc.) may be allocated based on the fault identification results. Following fault identification, additional prizes may be offered for fault repair. As described, the first submission that provides a fix to may receive the prize.

In general, in one aspect a system for providing a distributed quality assurance process for software using an online software development environment includes an online competition environment for conducting a first competition for the identification of faults in a software program wherein competition participants who identify faults in the software program are rewarded and for conducting a second competition for the repair of a specified fault identified in the first software competition, wherein submissions comprising modifications to the software program are received from developers in response to the specified fault identification, and a developer whose submission repairs the specified fault is rewarded; and a management subsystem for tracking progress of the competitions.

The software program may be in “alpha” or “beta” and may or may not have been previously deployed in a production environment. One or more portions of the software program may have previously been developed during a coding competition. The software program may be one or more selected from the group of a software component, a software application, a combination of software components, or a software module. The source code to the software program may be provided to the competition participants, or may not be. The source code to the software program may be provided to the competition participants subject to the agreement by the competition participants to confidentiality terms.

A description of the fault may be distributed along with the faulty software program. A software specification that describes the operation of the software program also may be distributed. The system also may include a reward subsystem for initiating payments to developers rewarded in the competitions.

Competitors may be rewarded for each fault identification submitted. Competitors may be rewarded for having the most fault identifications submitted in a competition. Competitors may be rewarded for having the most fault identifications submitted in a number of competitions. Competitors are rewarded for having the most fault repairs. Faults may identified using an automated distributed testing platform.

In general, in another aspect, a system for providing a distributed quality assurance process for software using an online software development environment includes a fault tracking system for receiving identification of faults in a software program, wherein each fault identification comprises a description of the fault and a classification of the fault and a competition posting system for posting a competition for the repair of the specified fault, wherein the competition specification comprises a fault received in the fault tracking system, and competition submissions comprise modifications to a software program that are received from developers in response to the specified fault identification, and a competition management system for rewarding a developer whose submission repairs a specified fault.

In some embodiments, each developer participating in the competition may be provided with an online development environment to be used in developing a repair for the specified fault.

Other aspects and advantages of the invention will become apparent from the following drawings, detailed description, and claims, all of which illustrate the principles of the invention, by way of example only.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a block diagram of an embodiment of a distributed software development system having a server according to the invention.

FIG. 2 is a flow chart depicting steps performed in developing a software program according to an embodiment of the invention.

FIG. 3 is a flow chart depicting an overview of the operation of another embodiment of the invention.

FIG. 4 is a block diagram depicting a software testing environment created with multiple submissions of test cases according to an embodiment of the invention.

FIG. 5 is a more detailed diagram of an embodiment of a testing environment such as that shown in FIG. 4.

FIG. 6 is a block diagram of an embodiment of a server such as that of FIG. 1 to facilitate the development and/or testing of software programs.

FIG. 7 is a block diagram depicting a software versioning environment according to one embodiment of the invention.

### DETAILED DESCRIPTION

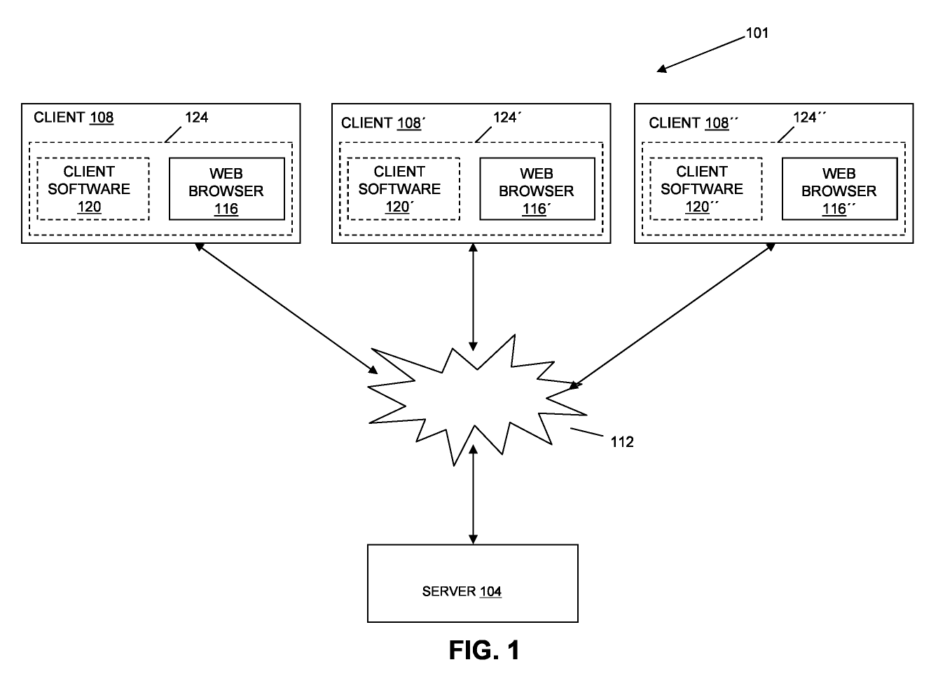

Referring to FIG. 1, in one embodiment, a distributed software development system 101 includes at least one server 104, and at least one client 108, 108′, 108″, generally 108. As shown, the distributed software development system includes three clients 108, 108′, 108″, but this is only for exemplary purposes, and it is intended that there can be any number of clients 108. The client 108 is preferably implemented as software running on a personal computer (e.g., a PC with an INTEL processor or an APPLE MACINTOSH) capable of running such operating systems as the MICROSOFT WINDOWS family of operating systems from Microsoft Corporation of Redmond, Wash., the MACINTOSH operating system from Apple Computer of Cupertino, Calif., and various varieties of Unix, such as SUN SOLARIS from SUN MICROSYSTEMS, and GNU/Linux from RED HAT, INC. of Durham, N.C. (and others). The client 108 could also be implemented on such hardware as a smart or dumb terminal, network computer, wireless device, game machine, music player, mobile telephone, wireless telephone, information appliance, workstation, minicomputer, mainframe computer, or other computing device, that is operated as a general purpose computer, or a special purpose hardware device used solely for serving as a client 108 in the distributed software development system.

Generally, in some embodiments, clients 108 can be operated and used by software developers to participate in various software development activities. Examples of software development activities include, but are not limited to software development projects, software design projects, testing software programs, creating and/or editing documentation, participating in development, support, and testing competitions, as well as others. Clients 108 can also be operated by entities who have requested that the software developers develop software (e.g., customers). The customers may use the clients 108 to review software developed by the software developers, post specifications or other documents and code associated with the development of software programs, initiate competitions, view competitions, test software modules, view information about the developers, interact with each other and with administrators, as well as other activities described herein. The clients 108 may also be operated by a facilitator, acting as an intermediary between the customers and the software developers.

In various embodiments, the client computer 108 includes a web browser 116, client software 120, or both. The web browser 116 allows the client 108 to request a web page or other downloadable program, applet, or document (e.g., from the server 104) with a web page request. One example of a web page is a data file that includes computer executable or interpretable information, graphics, sound, text, and/or video, that can be displayed, executed, played, processed, streamed, and/or stored and that can contain links, or pointers, to other web pages. In one embodiment, a user of the client 108 manually requests a web page from the server 104. Alternatively, the client 108 automatically makes requests with the web browser 116. Examples of commercially available web browser software 116 are INTERNET EXPLORER, offered by Microsoft Corporation, NETSCAPE NAVIGATOR, offered by AOL/Time Warner, or FIREFOX offered the Mozilla Foundation. Any other suitable architecture, including but not limited to widget frameworks also may be employed.

In some embodiments, the client 108 also includes client software 120. The client software 120 provides functionality to the client 108 that allows a software developer to participate, supervise, facilitate, or observe software development activities. The client software 120 may be implemented in various forms, for example, it may be in the form of a web page, widget, and/or Java or .Net applet that is downloaded to the client 108 and runs in conjunction with the web browser 116, or the client software 120 may be in the form of a standalone application, implemented in a multi-platform language/framework such as Java, .Net, or in native processor executable code. In one embodiment, if executing on the client 108, the client software 120 opens a network connection to the server 104 over the communications network 112 and communicates via that connection to the server 104. The client software 120 and the web browser 116 may be part of a single client-server interface 124; for example, the client software can be implemented as a “plug-in” to the web browser 116 or to another framework or operating system.

A communications network 112 connects the client 108 with the server 104. The communication may take place via any media such as standard telephone lines, LAN or WAN links (e.g., T1, T3, 56 kb, X.25), broadband connections (ISDN, Frame Relay, ATM), wireless links (802.11, bluetooth, etc.), and so on. Preferably, the network 112 can carry TCP/IP protocol communications, and HTTP/HTTPS requests made by the web browser 116 and the connection between the client software 120 and the server 104 can be communicated over such TCP/IP networks. The type of network is not a limitation, however, and any suitable network may be used. Non-limiting examples of networks that can serve as or be part of the communications network 112 include a wireless or wired ethernet-based intranet, a local or wide-area network (LAN or WAN), and/or the global communications network known as the Internet, which may accommodate many different communications media and protocols.

The servers 104 interact with clients 108. The server 104 is preferably implemented on one or more server class computers that have sufficient memory, data storage, and processing power and that run a server class operating system (e.g., SUN Solaris, GNU/Linux, and the MICROSOFT WINDOWS family of operating systems). Other types of system hardware and software than that described herein may also be used, depending on the capacity of the device and the number of users and the size of the user base. For example, the server 104 may be or may be part of a logical group of one or more servers such as a server farm or server network. As another example, there could be multiple servers 104 that may be associated or connected with each other, or multiple servers could operate independently, but with shared data. In a further embodiment and as is typical in large-scale systems, application software could be implemented in components, with different components running on different server computers, on the same server, or some combination.

In some embodiments, the server 104 also can include a contest server, such as described in U.S. Pat. Nos. 6,569,012 and 6,761,631, entitled “Systems and Methods for Coding Competitions” and “Apparatus and System for Facilitating Online Coding Competitions” respectively, both by Lydon et al, and incorporated by reference in their entirety herein.

In one embodiment, the server 104 and clients 108 enable distributed software fault identification and retrieval by one or more developers, which developers may or may not be associated with the entity requesting the these services. As described herein, a software program or software generally can be any sort of instructions for a machine, including, for example, without limitation, a component, a class, a library, an application, an applet, a script, a specification, prototype, a logic table, a widget, a data block, or any part, combination or collection of one or more of any one or more of these.

In one embodiment, the software program is a software component. Generally, a software component is a functional software module that may be a reusable building block of an application. A component can have any function or functionality. Software can be written in any suitable language, including without limitation Visual Basic, C++, Java, and C^{#}.

In one embodiment, the software program is an application. The application may be comprised of one or more software components. In one embodiment, the software application that undergoes fault identification and repair is comprised of software components. In some embodiments, the application comprises entirely new software programs. In some embodiments, the application comprises a combination of new software programs and previously developed software programs.

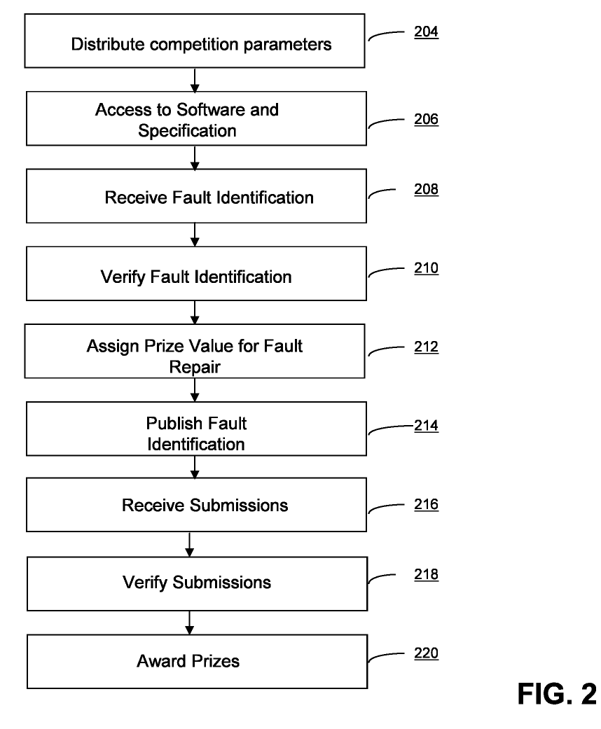

FIG. 2 provides a summary illustration of one embodiment of a method for identifying and repairing software faults, for example using the server described with respect to FIG. 1. In the first part of the method, steps, 204-210, a competition is held among developers to identify faults in a software program. A competition may be announced on the competition web server, by email, RSS and so forth, and the competition rules and parameters provided STEP 204. The competition parameters may include such parameters as the length of the competition, the prizes that may be awarded, the manner of review and submission, and so forth. Registration may be required prior to viewing of the competition parameters, although typically registration, if required, is required to participate and not to view the parameters. Potential competitors may review the parameters to decide whether or not to participate. Information about the software that is to be the subject of the competition, such as the type of software program and technology, may be specified, for example, so that a potential competitor can determine whether her skills match the project.

Information may be provided in the competition parameters about where to obtain or access the software program and/or the specification(s) for the software against which the software is to be tested for faults STEP 206. In some cases, software and/or specification each may be distributed together or separately, or made available by any or a combination of download, email, viewing on-line with a viewer or remote desktop application, and so forth.

The information/data/software program may be provided in a cloud computing environment, so that no download or configuration is necessary, such as described in co-pending U.S. patent application Ser. No. 12/180,095, entitled SYSTEM AND METHOD FOR CONDUCTING COMPETITIONS by Campion, filed on Jul. 25, 2008, incorporated herein by reference. The environment may be created, configured, and allocated to a competitor upon registration, as described therein.

In some cases, the specifications may include one or more of technical specifications, user manuals, design documentation, standards documents, and so on. Optionally, and depending on the competition, competitors may need to register for the competition in order to gain access to the software and/or specification. In some cases, competitors may need to complete certain prerequisites prior to gaining access, such as completion of documentation or legal agreements (e.g., confidentiality agreement, developments assignment agreement, tax documentation, identity information, biographical/demographic information, and so forth). In some cases, some documents or other prerequisites may be a requirement for submission or payment.

The software may be provided and run by the competitors in a variety of ways. In some cases, the software may be deployed in an environment that is accessible to competitors. For example, the competitors may “log in” to server to run the software. The software may be accessible via a web browser (for example, for web-based applications). The software may be accessible via a thin client (e.g., remote desktop). The software may be accessible by download and install on the competitor's computer, or on a device owned, rented, loaned, shared, or operated by a competitor, depending on the software, configuration, etc.

In some embodiments, competitors may use a distributed testing environment, such as that described in co-pending U.S. patent application Ser. No. 12/145,718, entitled DISTRIBUTED SOFTWARE TESTING by Campion. Such a distributed testing environment allows for testing of software on different platforms and different operating environments. Faults identified within such a framework may be provided to the competition system and logged. The operators of the system providing the tests may be rewarded for each fault accepted.

By running the software and/or reviewing the source code for the software, the competitors can attempt to identify faults in the software. The identification of faults can be accomplished by any suitable technique, to the extent not restricted in the competition rules and/or parameters. As a few examples, not intended to be limiting, identification of faults may be accomplished by writing and/or running test cases, by running the software in a production environment, by running the software in a test environment using test data, by reviewing the source code for the software, by reviewing the output of the software, by submitting test data to be used to test the software, by generating URLs (e.g., web page requests) by reviewing specifications and testing requirements, and so forth. Once identified, the faults are provided to and received by the competition server system STEP 208.

In a preferred embodiment, the faults are provided in a standard bug-tracking system, such as the JIRA system available from Atlassian Pty Ltd., Sydney, Australia (http://www.atlassian.com/software/jira/). In this way, the faults are entered in a manner that is familiar to the developers. In some competitions, the system may be configured to allow competitors to see entries from other developers during the competition, and in other cases, competitors can not see others' entries until the competition is over. In some embodiments, a special-purpose software application is used to receive and track fault identification submissions. In some cases, identified faults are requested to include instructions for reproducing the fault. In some cases, identified faults are requested to include or reference test cases or test code for verifying the fault. In some cases, identified faults are requested to include a designation of a fault category, which may be used to determine a suggested prize value for the fault repair. In some cases, identified faults are requested to include a suggested prize value for fault repair.

The fault identifications may be verified 210. In some embodiments, competition administrators and/or a designated review board verify the identified faults by implementing the instructions included in the fault identification for reproducing the fault. In some embodiments, competition competitors have the opportunity to attempt to verify, or prove incorrect, the identified faults. In some embodiments, a customer or other person, entity, or group with an interest in the software program verifies the faults. In some embodiments, a fault is considered to be verified if it is reported by a predetermined number of competitors. Fault verification may include any combination of such verification.

In some embodiments, competitors can gain points and/or prizes by verifying faults identified by other competitors. In one such embodiment, after a first competition phase in which competitors identify faults, a second competition phase is held in which competitors attempt to verify of determine to be incorrect the faults identified by others. Competitors may gain points and/or prizes for each fault that is verified, and may gain points and/or prizes for each fault identification that is shown to be incorrect. In some embodiments, in which submissions are made available to competitors as they are submitted, the faults can be identified and verified during a single phase of competition, and competitors can choose whether to try to identify new faults or to verify existing submissions, depending on the points/prizes offered and their anticipated likelihood of success.

In one embodiment, one or more developers from the distributed community of developers is assigned the task of verifying faults that are submitted. The developer is paid an amount for each fault that is reviewed. In an exemplary embodiment, developers are paid a fixed amount (e.g., $2, $4, $5, $10) for each fault identified by the developer that is accepted. Developer(s) who find the most faults receive an additional prize (e.g., $500 for first place, $250 for second place).

Once identified faults have been verified or determined not to be reproducible, a prize value is assigned to the fault identifications STEP 212. The prize value may be assigned by a system administrator and/or review board and/or competitors, based on a assessment of the difficulty of repair and/or the degree of severity. For example, in some embodiments, an administrator reviews the fault identifications, and assigns a prize value to them. The prize value may be assigned based on any or all of the assessment of one or more people, the type of fault, the degree of repair difficulty, the severity of the fault, specific customer interest or other priority, and so forth. In some embodiments, reviewers are asked to estimate the degree of difficulty for repairing the fault. In some embodiments, a customer (e.g., the owner of the software program) is asked to assign a prize value based on the perceived problem that the fault presents to the operation of the software.

In some embodiments, the fault identification includes a suggestion of prize value, and may be reviewed at the time of fault identification review. Prize value criteria may be provided to the fault identifying developers, for example, based on an assessed severity/criticality, difficulty, etc. For example, simple user interface wording changes may be assigned a first prize value (e.g., $25), more complicated changes assigned a second prize value (e.g., $50 or $100) and large business logic or problems that are difficult to repeat assigned a third prize value (e.g., $250 or $500).

In some embodiments, as competitors identify and/or verify the fault, they provide information about the difficulty and severity of the fault, and this information is used to assign a prize. In such cases, multiple competitors opinions may be taken into account, preferable without showing competitors the other competitors' estimates of difficulty to repair and severity. For example, if 1 competitor identified the fault, and 4 competitors reported that they reproduced the fault, all 5 of them may be asked to rate the difficulty of the repair and the severity of the problem. That information may be used to set prizes, particularly if it is consistent. If it is not consistent among the members, then it may be worthwhile for an administrator to take a look. Prizes (e.g., points, money, goods and/or services) may be awarded to competitors for their fault identification and verification.

In an exemplary embodiment, competitors are awarded 30 points for correctly identifying a fault, and 5 points for successfully reproducing and verifying a fault identified by others. Each fault can be reproduced by up to 5 other competitors. Competitors are awarded a fixed amount (e.g., 40 points) for correctly determining that a fault identified by another competitor was not a valid fault, and lose a fixed amount (e.g., 40 points) for incorrectly stating that an identified fault is in error. The competition lasts for 3 days. During that time, competitors can decide whether to find new faults, or to verify the faults identified by others. At the end of the competition, the results are tallied, faults not sufficiently verified by competitors are verified by an administrator, and the challenges to faults are verified. The points are used to divide up a prize pool. For example, if the prize pool is $1,000, the competitor with 20% of the points gets 20% of the prize pool (e.g., $200), and a competitor with 1% of the points gets 1% of the prize pool (e.g., $10), and so on. In addition or instead, the points may be used to buy other prizes, or are included in totals for a multi-contest prize pool. It should be understood that instead of points, dollars may be awarded, those with the most, or the most over some number of competitions may be awarded, and so on.

Once a prize value has been assigned to fault identification, the fault identification may be published or otherwise made available to competitors for fault repair. In some embodiments, fault repair takes place as a different competition, separate from the fault identification competition. In some embodiments, the fault repair takes place at the same time as the fault identification competitions. In this case, there may be separate competition parameters, registration, and so on. In some embodiments, fault identification and fault repair competitions are run in cycles, such as IDENTIFICATION-REPAIR-IDENTIFICATION-REPAIR-IDENTIFICATION-REPAIR, so that the software can be tested by the competitors with repairs made during the previous cycle. In some embodiments, the repair competitions are ongoing. As fault identifications are verified and a repair prize value assigned, the fault identifications are published to competitors for repair. The first competitor to fix the fault and submit the repair wins.

During the repair competition, submissions are received from competitors STEP 216 containing a repair to the identified fault. The repair may be in the form of a modified software program, which may include one or more of patches to the code, updated code, an entire source code distribution, scripts to modify the software, test cases to test the repair, and so on. The submissions may be provided using a bug tracking system in which the repair can be submitted as an attachment and/or a comment to the issue listing for the fault.

The submissions may be verified STEP 218. In some embodiments, competition administrators and/or a designated review board verify that the fault has been repaired. In some embodiments, competition competitors have the opportunity to attempt to verify, or prove incorrect, the repaired faults. In some embodiments, a customer or other person, entity, or group with an interest in the software program verifies the repair. In some embodiments, a repair is considered to be verified if it is verified by a predetermined number of competitors. Repair verification may include any combination of such verification.

It should be understood that in some cases the fault repair competitions can have a set time period and a designated prize amount. Repair of multiple faults may be aggregated into a single competition. In other cases, the fault identification may be posted along with the designated prize amount, and the first developer to successfully fix it wins. In such a case, faults not repaired after a predetermined time period (e.g., 4 hours, 12 hours, 1 day, 2 days, 1 week, 1 month, etc.) undergo a prize review by an administrator and/or an automatic increase to prize value, as an incentive for completion. By automatically increasing prizes, an auction is created, where developers might wait for the price to increase, understanding that it might get completed by another competitor in the meantime.

In some embodiments, competitors can gain points and/or prizes by verifying repairs identified by other competitors. In one such embodiment, after a first competition phase in which competitors submit repairs, a second competition phase is held in which competitors attempt verify the repairs submitted by others. Competitors may gain points and/or prizes for each repair that is verified, and may gain points and/or prizes for each repair submission that is shown not to completely correct the fault, or to introduce a different fault. In some embodiments, in which submissions are made available to competitors as they are submitted, the repairs can be submitted and verified during a single phase of competition, and competitors can choose whether to try to submit repairs or to verify existing repairs, depending on the points/prizes offered and their anticipated likelihood of success.

Prizes are awarded STEP 220. For the repair competitions, the assigned prize value may be awarded to the winner. It may be that an additional prize, or a portion of the prize is awarded to a runner-up, or to a competitor who verifies the fix, and so on. By putting the proper incentives in place, the distributed community of developers can have coordinated efforts in finding and fixing faults in software programs.

In some embodiments, points are awarded in both fault identification competitions and repair competitions. The points from both competitions (and in some cases others as well) are combined and used to allocate a prize pool (e.g., a pool of prize money or other benefits to be divided among a group of competitors). For example, the prize pool may be allocated proportionally to the points awarded or a disproportionate share may be allocated to the best performers. In some cases, additional prizes (from the pool or otherwise) may be assigned to highly-placed point winners (e.g., first place, second place), and so on.

In some embodiments, points and/or winnings from multiple competitions of the same type are combined and used to allocate a prize pool. Thus, results from a number of fault identification competitions may be aggregated and used to allocate a fault identification prize pool. In any case, the allocation of points may be combined with some monetary or other reward, in order to create both short-term and long-term incentives. Points may be combined for a specific number of competitions, or for competitions of a type or types during a particular time period. There may be a prize pool for a subgroup or time period, and another prize pool for a superset of multiple subgroups or time periods. The allocation of points and the awarding of prizes may be determined by an award subsystem on the server.

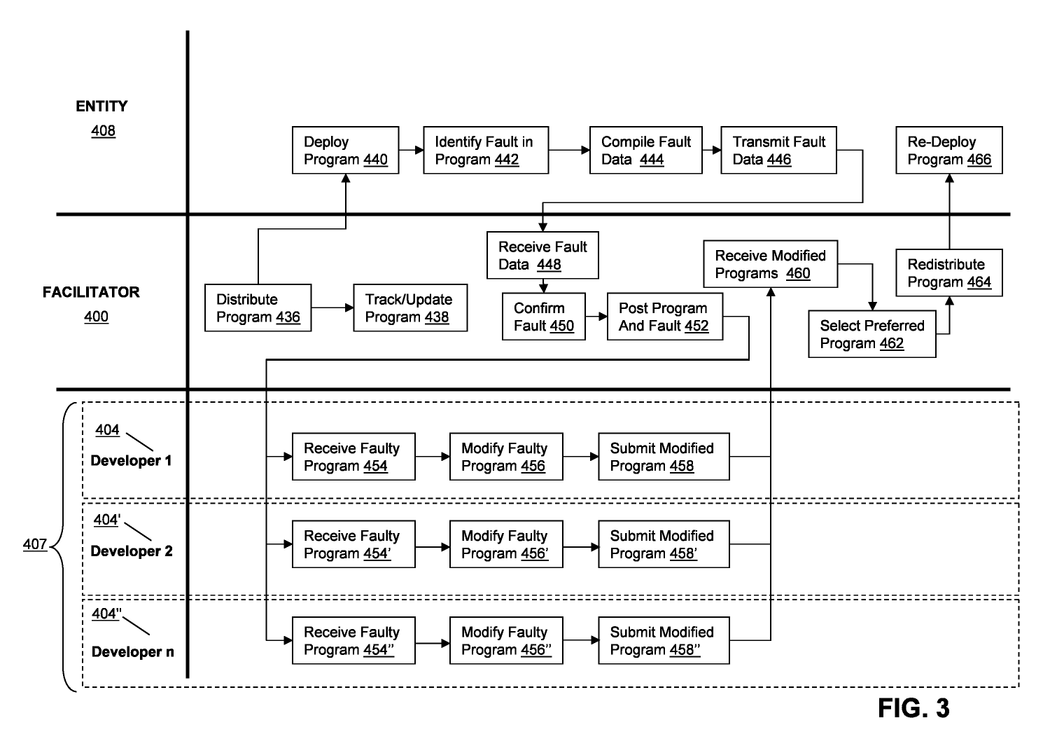

Referring to FIG. 3, in one embodiment, the distributed community of developers 404 are engaged to provide support for software programs. Support can be provided during implementation and deployment at an external entity 208, during a testing phase at the entity 208, as well as post-deployment—i.e. when the software program is “in production.” In some cases, the software programs are developed using the systems and methods described herein, and in some cases the software programs are developed using other methods, and subsequently sent to the facilitator 400 for inclusion in a software library, component store, or other such software artifact storage and distribution system. For example, even without a fault identification competition, users of an application may be requested to make a fault identification as described above, which would be used for a repair competition either alone or aggregated with other fault identifications.

The software program is deployed (STEP 440) by one or more external entities 208, for example, in a production environment, a testing environment, a development environment, or other computing environment where the software program is expected to operate according to the design and development specifications previously described. Typically, the software program has already passed tests and was believed to be fully functional.

At any time, the external entity 208 (or in some cases multiple entities) identify one or more faults (STEP 442) in the software program. For example, the software program may operate without incident, but fail to produce the expected output. As another example, the software may exhibit faulty behavior infrequently, for example if the software program lacks appropriate data input checks to assure that the data being used by the software program is of the correct format (e.g., integer, text, etc.) and does not contain invalid values. In other cases, the software program may function as designed under typical operations, but due to design choices such as field definition limits, stack limits, and transaction processing mechanisms, the program may fail when encountering high-volume operations. In other cases, the software operation is not erroneous, but is not optimal, for example, if all useful information is not displayed, additional functionality would be helpful, or if the operation of the software in its intended environment is slower than anticipated or desired. In still further cases, the external entity 208 may not be aware of any faults of the program, but wishes to have the program “vetted” by a community of software developers 212 to find any previously unnoticed faults as well as determining the most appropriate fix for any faults they find.

In each case, the entity 208 compiles as much fault data as possible (STEP 444), which in some cases may be none if they are requesting the program be further tested by the community of software developers 212. The fault data may include, by way of example, error messages, input data values, output data values, memory dumps, and/or code segments. In some embodiments, the external entity 208 supplies fully functional software programs that interact with the faulty software program to allow “system testing” at an application level in addition to the “unit testing” at the program or component level described above. In some cases, no fault data may be available, and the entity merely notes a failure or faulty behavior occurred. The entity 208 then provides the fault data (STEP 446) to the facilitator 400 who will oversee the resolution of the fault.

Once the facilitator 400 receives an indication (STEP 448) that a software program is not operating as expected and available fault data associated with that failure, a confirmation step may be used to determine if the program is in fact faulty. One method of testing the program is to use the fault data supplied by the entity 208 to attempt to recreate the fault. In embodiments where additional functional software programs are supplied, the facilitator may attempt to operate an entire software application comprising numerous software programs, the faulty software program being only a subset of the application to observe how the faulty program interacts with other programs. In cases where multiple test cases were submitted during the development of the program (as described below), the test cases may be re-run with the fault data supplied by the entity 208. In situations where the software program was developed based on design and development specifications that were compiled under the supervision of the facilitator using, for example, the methods described above, those documents are used to determine if the software program meets the original design and development requirements. If the facilitator 400 determines that the software program is operating as designed, the facilitator notifies the entity as such.

In some cases, faults in other software programs may be found, and those programs are then subject to the methods described herein. In other cases, the software program may be operating as specified, but the operational requirements of the program may have changed or, in many cases, not originally considered. Changes to the software program made to address new requirements (enhancements) may be incorporated into the software program using these same or similar methods. However, in some cases, the facilitator may decide to charge a fee for enhancing a software program. The fee may be a fixed fee or a fee determined by the complexity of the enhancement and/or the time necessary to implement the enhancement. Such fees may be documented in, for example, a support services contract negotiated between the facilitator 400 and the entity 208, or in some cases determined on a “one-off” basis as faults are found.

Having determined that a fault exists (or, as described above, an enhancement is needed), the facilitator 400 posts the program (STEP 452), and in some embodiments also posts documentation regarding the program and the fault. The documentation may include, for example, fault data, and in some cases documentation describing the fault, the intended operation of the program, the design document, the development specification, and the operational environment of the program. Other information such as the date or time that any updated versions of the program are needed and any rewards (e.g., points, money) for submitting the selected updated version can also be included in the posting. In some cases, the posting may be available to the entire distributed community of programmers, whereas in other cases the posting may be limited to a subset of the community having, for example, a minimum skill rating, or a certain identified programming expertise. The posting may also be made available (either exclusively or in addition to other members of the community) to the individual(s) that originally designed and/or developed the program using the methods described above. The posting may be achieved, for purposes of example, by placing a copy of the software program on a web site, and FTP site, distributing the program via email, or any combination thereof.

Developers 404 are notified of (or inquire about) a faulty software program and those that are identified as qualified recipients receive the program (STEP 454) using one or more of the methods described above. In addition to receiving the faulty software program and the related documentation, test scripts, data, and other information that can be used to identify and resolve the fault, the developers also, in some cases, receive a deadline by which modifications must be submitted, and may also be informed of one or more prizes (e.g., money, a skill rating, etc.) that are available to the developer 404 that submits the preferred fix. The developers 404, using either their own programming/development environments or, for example, in some cases, using an online development and testing environment provided by the facilitator 404, analyze and modify the faulty program (STEP 456) such that it is no longer faulty. When a developer is satisfied that their modifications address the identified faults, (as well as any they may have identified subsequent to their receiving the program) they submit their modified program (STEP 458) to the facilitator 400 for testing and analysis. The developer also may be required to submit test cases that test for the identified fault. In some embodiments, test cases from multiple developers may be used against a single submission, using, for example, the methods described below.

Still referring to FIG. 3, the facilitator 400 receives each of the modified programs (STEP 460) and, based on one or more decision parameters, the review board selects a preferred program (STEP 462) from among those submitted by the developers. The selection process can include review of the changes to the program, testing the modified program to assure the previously identified fault has been addressed, testing the overall functionality of the program, and/or the speed with which the program operates. In some embodiments, a deadline is established by which the developers must submit their modifications in order to be considered for the selection process. In certain circumstances, for example for smaller projects or those requiring exceptionally quick turnaround, the first submission that successfully addresses the fault may be selected as the preferred program. Once a preferred program is selected, it is redistributed (STEP 464) to the entity 208, where it is deployed (STEP 466) for further testing and/or use in one or more production environment(s). In some embodiments, the preferred program is also distributed to other entities that have previously deployed the program, but may or may not have identified the fault, using, for example the version control and distribution systems and methods described in more detail below. For example, if the fault repair included changes to a software component, other software applications may be using the same component.

In general, developers are encouraged to develop test cases as they are coding so that they can consider the bounding and error conditions as they code. It can be beneficial to use the test cases developed by one or more, or all, of the other submitters to test each of the submitted programs to cover as many error conditions as possible.

As mentioned above, in some embodiments, the developers 404 submit one or more test cases in addition to submitting the completed software program and/or the updated software program. A purpose of the test cases is to provide sample data and expected outputs against which the program can run, and the actual output of which can be compared to the expected outputs. By creating additional test cases that test for the identified fault, the developer ensures that the fault will be noticed if accidentally reinserted into the code later. By submitting multiple test cases, many different scenarios can be tested in isolation, therefore specific processing errors or omissions can be identified. For example, a program that calculates amortization tables for loans may require input data such as an interest rate, a principal amount, a payment horizon, and a payment frequency. Each data element may need to be checked such that null sets, zeros, negative numbers, decimals, special characters, etc. are all accounted for and the appropriate error checking and messages are invoked. In addition, the mathematical calculations should be verified and extreme input values such as long payment periods, daily payments, very large or very small principal amounts, and fractional interest rates should also be verified. In some versions, one test case can be developed to check each of these cases, however in other versions, it may be beneficial to provide individual test cases for each type of error. In certain embodiments, the multiple test cases can then be incorporated into a larger test program (e.g., a script, shell, or other high level program) and run concurrently or simultaneously. Where the program was identified as a faulty software program, the suite of test cases tests the updated programs using, for example, the test data that caused the faulty program to fail, an operating environment in which the software program did not operate as expected, or other processes identified as causing the program to fail.

It should be understood that the tasks described could be reallocated. Just as one example, step 448, described above as performed by a facilitator, could likewise be performed by a developer. Similarly, evaluation of the updated code could be performed by one or more review boards or teams.

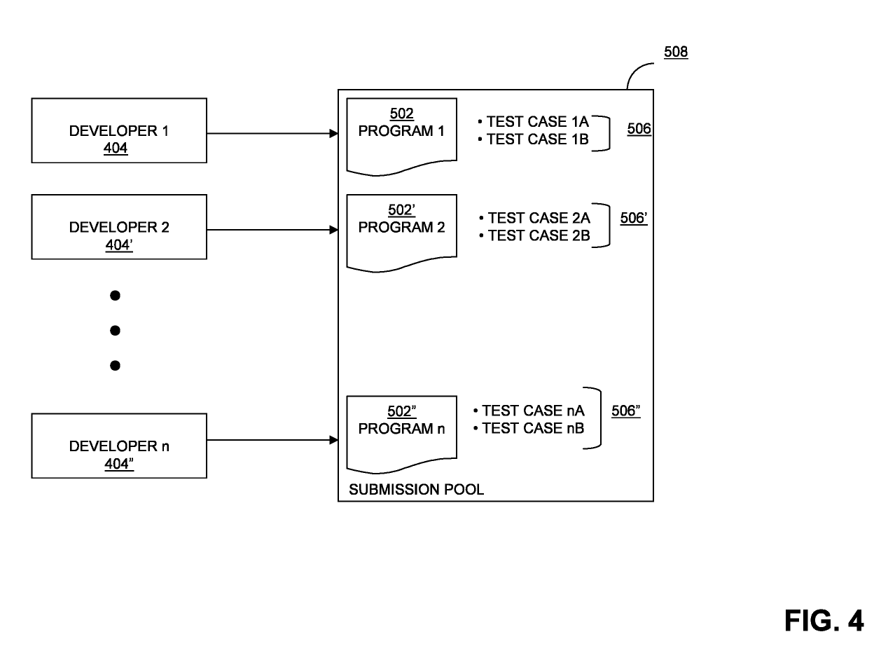

Referring to FIG. 4, in a demonstrative embodiment, developers 404, 404′ and 404″ each submit software programs that may include a fault repair 502, 502′ and 502″ respectively to the development domain 204 in response to the communicated software (e.g., fault identification(s)) referred to above. In addition to submitting the programs, the developers 404 also submit one or more test cases 506, 506′, and 506″. For example, when DEVELOPER 1 404 submits PROGRAM 1 502, she also submits TEST CASE 1A and TEST CASE 1B, collectively 506. DEVELOPER 2 404′ and DEVELOPER 3 404″ do the same, such that after all three developers 404 have completed their submission, the development domain 204 includes a submission pool 508 comprising three submitted programs and six test cases. Even though it is likely that DEVELOPER 1 404 ran TEST CASE 1A and 1B 506 that she submitted against her PROGRAM 502, it is also possible that the test cases 506′ and 506″ submitted by DEVELOPER 2 404′ and DEVELOPER 3 404″ respectively address cases or data not contemplated by DEVELOPER 1 404. Therefore, it can be advantageous to run each test case submitted by all of the developers against each of the submitted programs in an attempt to identify all potential faults of each submitted program. In some versions, a subset of the submitted test cases may be eliminated from the submission pool 508, or not used, for example, because they are duplicative, do not test necessary features, or are incorrect. If so, a subset of the test cases in the submission pool 508 can be used to test the submitted programs. Because the programs are tested more rigorously (i.e., using a suite of test cases submitted by numerous developers) the quality of the resulting programs is likely to be greater than that of programs tested only by those that developed the selected program.

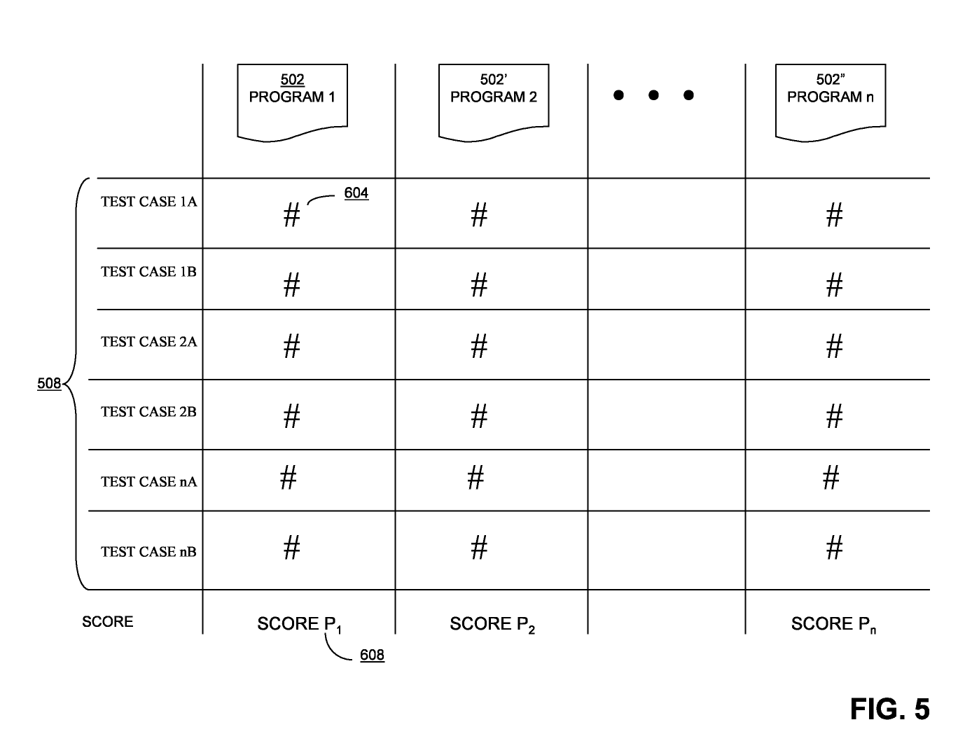

Referring to FIG. 5, the test cases in a submission pool 608 may be applied to the submitted programs 502, 502′, 502″. In some cases, all of the test cases in the pool 608 are applied to every submitted program, whereas in some versions only a subset of the submitted test cases are used. In some embodiments, certain programs may be eliminated from contention by running a first test case against it, such that subsequent test cases are not necessary. In some versions, each application of test case 608 to a program results in a score 604. The scores 604 for each application of test case 608 to submitted program can then be tabulated and aggregated into a combined, or overall score for that particular program. Some test cases have a higher or lower weight than others such that the scores for a particular test case may be more indicative of the overall quality of the program, or the results are more meaningful. In other cases, the scores may be binary—i.e., a passed test receives a score of “1” and a failed test receives a score of “0.” In some embodiments the tabulation and aggregation can be automated on the server 104.

In some embodiments, developers that submit fault identifications and fault repairs (e.g., in the form of designs and/or developed code) are rated based on the scores of their submissions. The ratings are calculated based on the ratings of each developer prior to the submission, the assigned difficulty level of the fault identification or repair submitted, and the number of other developers making submissions. It should be understood that a submission could be one design, program, or other computer software asset, or in some cases a number of different assets. A skill rating is calculated for each developer based on each developer's rating prior to the submission and a constant standard rating (e.g., 1200), and a deviation is calculated for each developer based on their volatility and the standard rating.

The expected performance of each developer submitting a design or program is calculated by estimating the expected score of that developer's submission against the submissions of the other developers' submissions, and ranking the expected performances of each developer. The submission can be scored by a reviewer using any number of methods, including, without limitation, those described above.

Based on the score of the submitted software and the scores of submissions from other developers (e.g., whether for the same program or one or more other programs having a similar level of difficulty), each developer is ranked, and an actual performance metric is calculated based on their rank for the current submission and the rankings of the other developers. In some cases, the submissions from other developers used for comparison are for the same program. In some cases, the submissions from other developers are submissions that are of similar difficulty or scope.

A competition factor also can be calculated from the number of developers, each developer's rating prior to the submission of the design or program, the average rating of the developers prior the submissions, and the volatility of each developer's rating prior to submission.

Each developer can then have their performance rated, using their old rating, the competition factor, and the difference between their actual score and an expected score. This performance rating can be weighted based on the number of previous submissions received from the developer, and can be used to calculate a developer's new rating and volatility. In some cases, the impact of a developer's performance on one submission may be capped such that any one submission does not have an overly significant effect on a developer's rating. In some cases, a developer's score may be capped at a maximum, so that there is a maximum possible rating. The expected project performance of each developer is calculated by estimating the expected performance of that developer against other developers and ranking the expected performances of each participant. The submissions and participants can be scored by the facilitator 400, the entity 208, a review board member, and/or automatically using the software residing, for example, on the server 104 using any number of methods.

In the case of fault identification and/or repair, for example, the score may be based in whole or in part on the number of faults identifications or repairs from a developer that are accepted and the number of fault identifications or repairs from all developers that are accepted. The number may be weighted by the types, speed, ratio of acceptable or correct submissions to unacceptable, and so forth. An online scorecard also may be used.

One such example of rating methodology is described in U.S. Pat. No. 6,569,012, entitled “Systems and Methods for Coding Competitions” by Lydon et al, at, for example, column 15 line 39 through column 16 line 52, and column 18 line 65 through column 21 line 51, and incorporated by reference in their entirety herein. The methodology is described there with reference to programming competitions, and so is applicable to rating the development (including without limitation fault identification and fault repair) of software or hardware designs, data models, applications, components, and other work products created as a result of using the methodology described above.

There can be a significant benefit to using personnel who are rated highly, using the process described above, as reviewer(s). One of the traditional problems with conducting code reviews, for example, has been that the abilities of the reviewers were not established. Review by a poorly skilled developer can result in an inadequate review. By using the process to select as reviewers only developers with sufficient skill (as determined by the process), the process itself insures its success. Use of additional criteria, such as expertise and/or rating with the appropriate technology also may be helpful.

In one embodiment, this software development process is adopted by a software development group within an organization. The development performed by the group is conducted using this process. Each developer in the group has a rating, and the developers work to improve and/or maintain their ratings. Developers who have high ratings can participate in reviews (e.g., the design review process or the code review process). In one implementation, developers receive additional benefits and or compensation for achieving a high rating. Likewise, developers can receive additional benefits and/or compensation for such participation in a review process. The requesters in this example are product or program managers, charged with directing the software development.

In another implementation, an outside organization such as a consultant can use the system and methods described above to evaluate and rate the development competencies of a development group. In this way, the consultant can rate the developers not only against themselves, but against other developers affiliated with other organizations who have participated or are participating in the system. The evaluator provides the service of evaluation and reporting as described above. One benefit to this approach is that the scoring of the intellectual assets is more likely to be unbiased if the reviewers are not personally known to the developers, and comparing the skills of any one developer against a large pool of developers provides a more accurate representation of that developers skill level with respect to his or her peers.

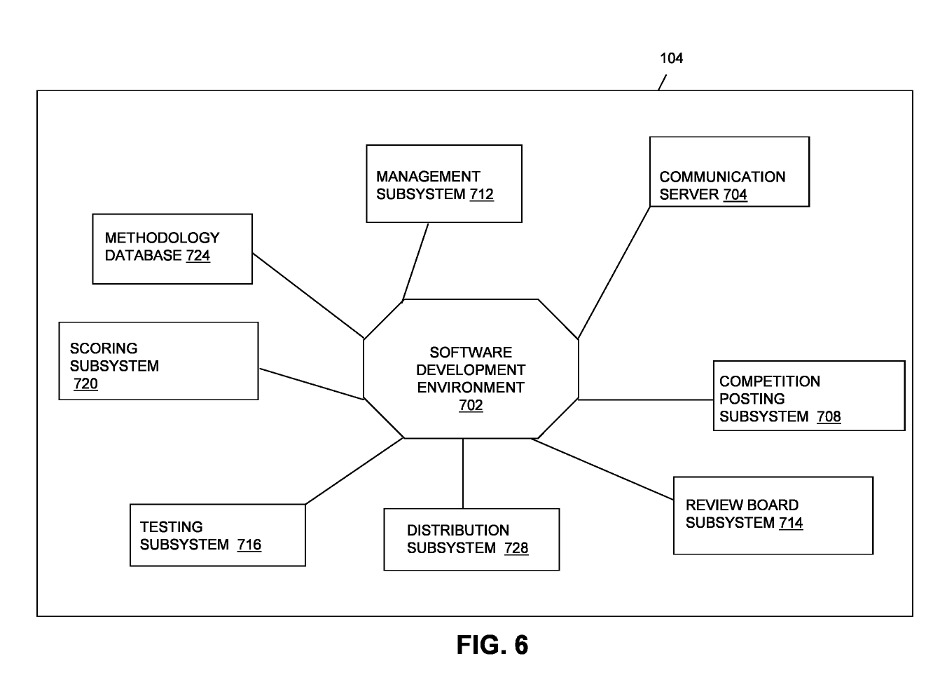

Referring to FIG. 6 the server 104 can include a number of modules and subsystems to facilitate the communication and development of software specifications, designs and programs. The server 104 includes a communication server 704. One example of a communication server 704 includes a web server that facilitates HTTP/HTTPS and other similar network communications over the network 112, as described above. The communication server 704 includes tools that facilitate communication among the distributed community of programmers 212, the external entity 208, the facilitator 400, and the members of the review board(s) (commonly referred to as “users”). Examples of the communication tools include, but are not limited to, a module enabling the real-time communication among the developers 404 (e.g., chat), news groups, on-line meetings, and document collaboration tools. The facilitator 400 and/or the external entity 208 can also use the communication server 704 to post design or specifications for distribution to the distributed community of programmers 212.

Furthermore, the server 104 may also include a software development environment 702 to facilitate the software development domain 204 and the design and development process, for example, and the subsystems and modules that support the domain 204. For example, the server 104 can include a development posting subsystem 708, a management subsystem 712, a review board subsystem 714, a testing subsystem 716, a scoring subsystem 720, a methodology database 724, and a distribution subsystem 728.

In one embodiment, the competition posting subsystem 708 allows users of the system to post specifications, submit designs, post selected designs, requests for fault identification competitions and/or fault repair competitions, submit software programs and test cases, and post selected software programs for distribution. The competition posting subsystem 708 may identify the users based on their role or roles, and determine which functions can be accessed based on individual security and access rights, the development phase that a project is currently in, etc. For example, if a particular project is in the design phase, the competition posting subsystem 708 can determine that the external entity sponsoring the project has read/write access to the specification, and can re-post an updated specification if necessary. A facilitator may have read access to the specification, for example, as well as access to other specifications attributed to other external entities they may support. In some embodiments, the entire distributed community of programmers may be able to view all of the currently pending specifications, however the posting subsystem may limit full read access to only those developers meeting one or more skill or rating criteria, as described above. Once designs are submitted, access to the submitted designs can be further limited to only review board members, or in some cases other participants in the process.

The competition posting subsystem 708 also enables the server 104 or other participants to communicate with potential developers to promote development projects and grow the community of programmers that participate in the development process. In one embodiment, the development posting subsystem 708 displays an advertisement to potential developers. In one embodiment, the advertisement describes the project using text, graphics, video, and/or sounds. Examples of communication techniques include, without limitation, posting ads on the server's web site, displaying statistics about the project (e.g., planned royalties paid to developers, developers who are participating in this project, development hours available per week). Moreover, in one embodiment the development posting subsystem 708 accepts inquiries associated with development projects. In further embodiments, the development posting subsystem 708 suggests development opportunities to particular developers. The development posting subsystem 708 may analyze, for example, the rating of each member of the distributed community, previous contributions to previous development projects, the quality of contributions to previous component development projects (e.g., based on a score given to each developer's submission(s) as discussed above), and current availability of the developer to participate.

The server 104 also includes a management subsystem 712. The management subsystem 712 is a module that tracks the progress of competitions using the software development environment 204. The management subsystem 712 also facilitates the enrollment of new users of the system, and assigns the appropriate security and access rights to the users depending on the roles they have on the various projects. In some versions, the management subsystem 712 can also compile and track operational statistics of the software development environment 204 and users of the system. For example, to determine the appropriate compensation to be awarded to a developer submitting a wining design, the management subsystem 712 may review previously completed projects and assign a similar cash award. Similarly, in cases where the difficulty level of a posted design or program is very high, the management subsystem 712 can review information about individual programmers to determine those developers who have historically performed well on like projects. In addition, the management subsystem 712 may be used to analyze overall throughput times necessary to develop operational programs from a specification provided by an external entity. This can assist users of the system in setting the appropriate deliverable dates and costs associated with new projects. The management subsystem 712 also may include a payment subsystem, for designating and/or initiating payments to developers who have been rewarded in competitions.

The server 104 also includes a review board subsystem 714. The review board subsystem 714 allows review board members, external entities, the facilitator, and in some cases developers in the distributed community to review submissions from other developers, as described above. In one embodiment, the communication server 704, the development posting subsystem 708, the management subsystem 712, the review board subsystem 714, the testing subsystem, the scoring subsystem, and the methodology database reside on the server 104. Alternatively, these components of the software development environment 204 can reside on other servers or remote devices.

The server 104 additionally includes a testing subsystem 716. The testing subsystem 716 enables the testing of the submitted programs, applications and/or components. In one embodiment, the testing server 708 is used by the review boards, the facilitator 400, and/or the external entity 208 to review, evaluate, screen and test submitted designs and software programs. The testing subsystem 716 can also execute test cases developed and submitted by the developer 404 against some or all of the submitted programs, as described above. Moreover, the testing subsystem 716 may execute an automated test on the component or application, such as to verify and/or measure memory usage, thread usage, machine statistics such as I/O usage and processor load. Additionally, the testing subsystem 716 can score the component by performance, design, and/or functionality. The testing subsystem 716 can be a test harness for testing multiple programs simultaneously.

The server 104 also includes a scoring subsystem 720. In one embodiment, the scoring subsystem 720 calculates scores for the submissions based on the results from the testing subsystem 716, and in some embodiments ratings for each participant in one or more coding competitions, previous development submissions, or both. In other embodiments, the scoring subsystem 720 can calculate ratings for developers based on their contributions to the project.

The server 104 also includes a methodology database 724. The methodology database 724 stores data relating to the structured development methodology 220. In one embodiment, the methodology 220 may stipulate specific inputs and outputs that are necessary to transition from one phase of the development project to the next. For example, the methodology 200 may dictate that, in order to complete the specification phase of the project and being the design phase, a checklist of items must be completed. Furthermore, the methodology database 724 may store sample documents (e.g., scorecards), designs, and code examples that can be used as templates for future projects, and thus impose a standardized, repeatable and predictable process framework on new projects. This standardization reduces the risks associated with embarking on new software development projects, shortens the overall duration of new development projects, and increases the quality and reliability of the end products.

The server 104 also includes distribution subsystem 728. The distribution subsystem 728 can track and store data relating to software products (e.g., specifications, designs, developed programs) that have been produced using the domain 204. In one embodiment, the distribution subsystem 728 includes descriptive information about the entity 208 that requested the product, the entry and exit points of the domain 204, significant dates such as the request date and the delivery date, and the names and/or nicknames of the developers that participated in the development of the product. The distribution subsystem 728 can also include detailed functional information about the product such as technology used to develop the product, supported computing environments, as well as others. In some embodiments, previously distributed software products may be updated or patched, as described above. In such cases, the distribution subsystem 728 facilitates the identification of the entity or entities 208 that may have older versions of the product, and subsequent communication and distribution of updated versions, where applicable. In some cases, the distribution subsystem 728 can also function as a source code management system, thereby allowing various versions of previously developed software products to branch into distinct software products having a common provenance. It should be understood that updated versions may include an update of the entire program, a patch or directed change to a portion of the program, a replacement code or module, or another other mechanism for communicating information to update a version.

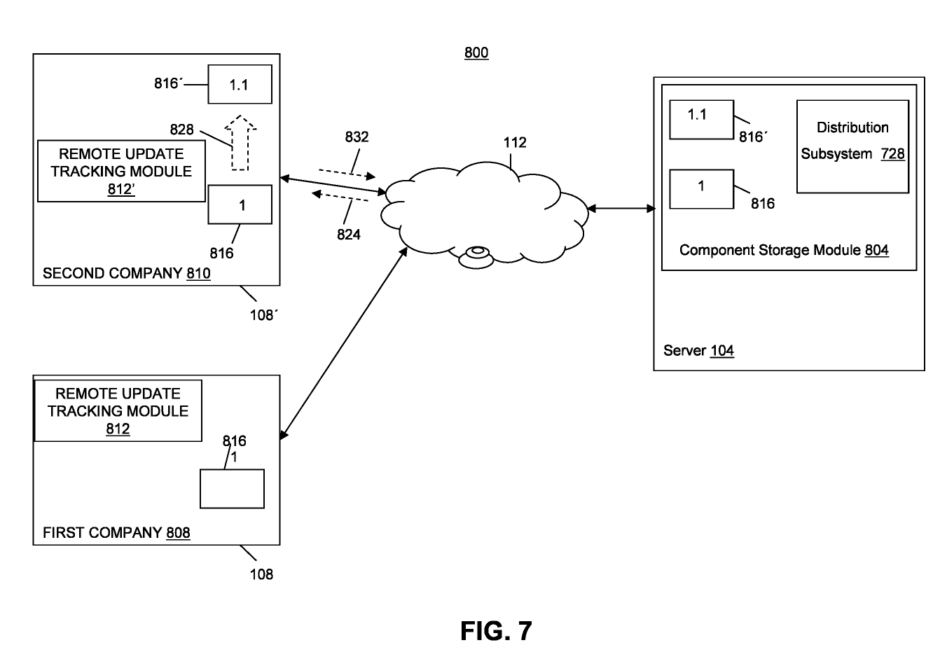

Referring to FIG. 7, in one embodiment a first company 808 and a second company 810 purchase, license, or sponsor the development of a version 1 of a software program, component, or application. After receiving the program, the second company 810 modifies the program 816, shown with modification arrow 828. A modification is, for example, an improvement (e.g., efficiency increase, smaller memory requirements), deletion (e.g., of an unneeded step or feature), and/or an addition (e.g., of a complimentary feature or function) to the program 816. Another example of a modification is the integration of the program 816 into another program, component, or application. In response to the modification, version 1 of the component 816 becomes, for example, version 1.1 of the program 816′. In one embodiment, the remote update tracking module 812 transmits a message to the server 104 stating that the second company 808 has modified the component 816. In further embodiments, the remote update tracking module 812 then transmits (or, e.g., queries and transmits) the modified version 1.1 to the server 104, as shown with arrow 832. Upon receipt of version 1.1 of the program 816′, the server 104 and/or development team members determine whether the modified component 816′ can be added to the component storage module 804 by, for example, performing the steps illustrated in FIG. 3. In one embodiment, when version 1.1 of the program 816′ is added to the component storage module 804, version 1.1 replaces version 1 of the program 816. Alternatively, version 1.1 of the component 816′ is added as another component in the component storage module 804. The replacement or addition of version 1.1 of the program 816′ may depend on the amount of changes relative to version 1 of the component. Furthermore, the update tracking module 812 may notify each customer who previously purchased version 1 of the program 816 (i.e., the first company 808) that an updated version 1.1 has been added to the component storage module 804. Additionally, in some embodiments the second company 810 is compensated for licenses/sales of copies of the second version of the program 816′. For example, compensation for creating a new program can take the form of monetary compensation, prizes, credits towards future software purchases, and/or rating points. In some embodiments, the system operates in a similar manner to distribute updates following fault identification and/or repair.

The programmers can be paid a fee for their work on the software program. In one embodiment, programmers receive a royalty based on their contribution to the software program and the revenue earned from licenses or sales of copies of the program. The server 104 tracks particular characteristics for determining the royalty amounts to be paid to the programmers. In one such embodiment, the fee is an advance payment on royalties, meaning that royalties are not paid until the advance is covered.

In one embodiment, the server 104 tracks a total revenue, a programmer contribution, a programmer royalty percentage, a royalty pool percentage, a royalty pool, and a royalty for each software program and/or for each program. The contribution is, for example, a predetermined amount based on the fault being fixed. In another embodiment, the contribution of a programmer is determined by the amount of time, level of skill (determined by previous scores, contest rating, experience or a combination), or degree of effort made by the programmer to fix the faulty software. In another embodiment, the contribution is determined by the usefulness of the programmers contribution. The expected proportional contribution of programmer to the overall royalties for a particular software program can be a fixed amount (e.g., 5% of the total royalties) or a scaled amount based, for example, on the severity of the fault that was fixed. In some cases, the entire royalty may be reallocated from the original developer of the software program to the programmer that fixed a fault in the program. In the event that the program is changed, upgraded or otherwise modified, an adjustment may be made to the development team member's royalty percentage for that modified version, to reflect the new contribution division.

Although described above as independent subsystems and modules, this is for exemplary purposes only and these subsystems and modules may alternatively be combined into one or more modules or subsystems. Moreover, one or more of the subsystems described above may be remotely located from other modules (e.g., executing on another server 104 in a server farm).

Although described here with reference to software, and useful when implemented with regard to software components, the cooperatively developed product can be any sort of tangible or intangible object that embodies intellectual property. As non-limiting examples, the techniques could be used for computer hardware and electronics designs, or other designs such as architecture, construction, or landscape design. Other non-limiting examples for which the techniques could be used include the development of all kinds of written documents and content such as documentation and articles for papers or periodicals (whether on-line or on paper), research papers, scripts, multimedia content, legal documents, and more.

What is claimed is:

1. A system for providing a distributed quality assurance process for software using an online software development environment comprising:
an online competition environment for conducting a first competition for the identification of faults in a software program wherein competition participants who identify faults in the software program are rewarded and for conducting a second competition for the repair of a specified fault identified in the first software competition, wherein submissions comprising modifications to the software program are received from developers in response to the specified fault identification, and a developer whose submission repairs the specified fault is rewarded; and
a management subsystem for tracking progress of the competitions.

2. The system of claim 1 wherein the software program has not been previously deployed in a production environment.

3. The system of claim 1 wherein one or more portions of the software program had previously been developed during a coding competition.

4. The system of claim 1 wherein the software program is one or more selected from the group of a software component, a software application, a combination of software components, or a software module.

5. The system of claim 1 wherein the source code to the software program is provided to the competition participants.

6. The system of claim 5, wherein the source code to the software program is provided to the competition participants subject to the agreement by the competition participants to confidentiality terms.

7. The system of claim 7 further comprising distributing the description of the fault along with the faulty software program.

8. The system of claim 1 further comprising distributing a software specification that describes the operation of the software program.

9. The system of claim 1, further comprising a reward subsystem for initiating payments to developers rewarded in the competitions.

10. The system of claim 1 wherein the competitors are rewarded for each fault identification submitted.

11. The system of claim 10 wherein the competitors are rewarded for having the most fault identifications submitted in a competition.

12. The system of claim 1 wherein competitors are rewarded for having the most fault identifications submitted in a number of competitions.

13. The system of claim 1 wherein competitors are rewarded for having the most fault repairs.

14. The system of claim 1 wherein faults are identified using an automated distributed testing platform.

15. A system for providing a distributed quality assurance process for software using an online software development environment comprising:
a fault tracking system for receiving identification of faults in a software program, wherein each fault identification comprises a description of the fault and a classification of the fault;
a competition posting system for posting a competition for the repair of the specified fault, wherein the competition specification comprises a fault received in the fault tracking system, and competition submissions comprise modifications to a software program that are received from developers in response to the specified fault identification;
a competition management system for rewarding a developer whose submission repairs a specified fault.

16. The system of claim 16 wherein each developer participating in the competition is provided with an online development environment to be used in developing a repair for the specified fault.
